(19) United States
(12) Patent Application Publication
(10) Pub. No.: US 2011/0139598 A1
(43) Pub. Date: Jun. 16, 2011

(54) DISTILLATION COLUMN WITH FIREBREAK DEVICE

(76) Inventors: Marc Wagner, Saint maur des fosses (FR); Phillippe Grigoletto, Villeparisis (FR); Jean-Marc Bernhardt, La Bruisse (FR); Emmanuel Fano, La Varenne Saint Hilaire (FR)

(21) Appl. No.: 11/911,329

(22) PCT Filed: Mar. 29, 2006
(86) PCT No.: PCT/FR2006/008979

§ 371 Date: Aug. 27, 2009

(30) Foreign Application Priority Data
Apr. 13, 2005 (FR) 0550942

(51) Int. Cl. B01D 3/32

(52) U.S. Cl. 202/158

(57) ABSTRACT

The invention concerns a distillation column (1) comprising means (21) for conveying at least one mixture to be distilled to the column, means (23) for drawing at least one fluid enriched in one constituent of the mixture from the column, inside the column, an evaporator-condenser (3) and means (25) for conveying a gas to be condensed and a liquid to be evaporated to the evaporator-condenser as well as means for removing the condensed gas and the evaporated liquid, at least one module of packing materials (5) located above the evaporator-condenser and at least one firebreak barrier (7A, 7B, 7C) between the evaporator-condenser and the module of packing materials.

The present invention relates to distillation columns with a firebreak device, and in particular to air distillation columns having such a device.

The article “Minimize the Risk of Fire During Column Maintenance” by Ender et al., CEP, September 2003 explains that most fires in a distillation column are due to the use of structured packings, particularly those made of aluminum.

Aluminum vaporizers in the columns of an air-separation unit may give rise to hot spots owing to local combustion of the aluminum of the corrugations initiated by a local build-up of hydrocarbons.

The possibility of initiating combustion of the aluminum of the packings located above the vaporizer is considered to be a serious situation.

To reduce the risk of a fire in the vaporizer spreading to the packings, it is common practice to use a double insulation wall between the vaporizer and the packing, imposing expensive connecting pipework external to the column. Otherwise the column may contain copper packing modules just above the vaporizer, which is also an expensive solution.

An object of the invention is to provide a distillation column comprising:
i) means for bringing at least one mixture to be distilled to the column;
ii) means for withdrawing at least one fluid enriched with a component of the mixture from the column;
iii) inside the column, a condenser-vaporizer and means for sending a gas to be condensed and a liquid to be vaporized to the condenser-vaporizer and means for withdrawing the condensed gas and the vaporized liquid; and
iv) at least one packing module located above the condenser-vaporizer,
   characterized in that it includes at least one firebreak barrier placed between the condenser-vaporizer and the packing module, and also means for letting fluids flow inside the column between the module and the condenser-vaporizer.

According to other aspects of the invention, the column includes:
a first barrier obstructing a first portion of the section of the column equal to at least half of the section and a second barrier obstructing a second portion of the section of the column equal to at least half of the section and at most partly covering the first portion of the section of the column, the first and second barriers being located between the condenser-vaporizer and the first packing module above the condenser-vaporizer, the first barrier being below the second barrier;
at least a third barrier above the second barrier and below the first packing module, obstructing a second portion of the section of the column equal to at least half of the section and at most partly covering the second portion of the section of the column;
the second portion of the section covers between 10 and 90% of the third portion of the section;
the first portion of the section covers between 10 and 90% of the second portion of the section;
the (or the first) barrier, and optionally the third barrier, consists of a disk coaxial with the column and obstructing a first section having a radius equal to between 50% and 100% of the radius of the column at the vaporizer;
the second barrier is an annular barrier having an outer radius substantially equal to that of the column at the vaporizer and having an inner radius greater than 20% of that of the column at the vaporizer;
the barriers are at least partly made of copper or a copper alloy;
at least one barrier, preferably the lowest and therefore the closest to the vaporizer, is filled with ceramic, quartz or glass beads;
at least one of the barriers is circular and/or at least one of the barriers is annular; and
at least one of the barriers is centered on the vertical axis of the column.

The invention also comprises an air distillation unit having at least one column as described above.

The packings are preferably made of aluminum or copper, of the cross-corrugated type, with or without modifications of the edges in order to reduce the resistance to gas flow.

The invention will be described in greater detail with reference to the following figures, in which

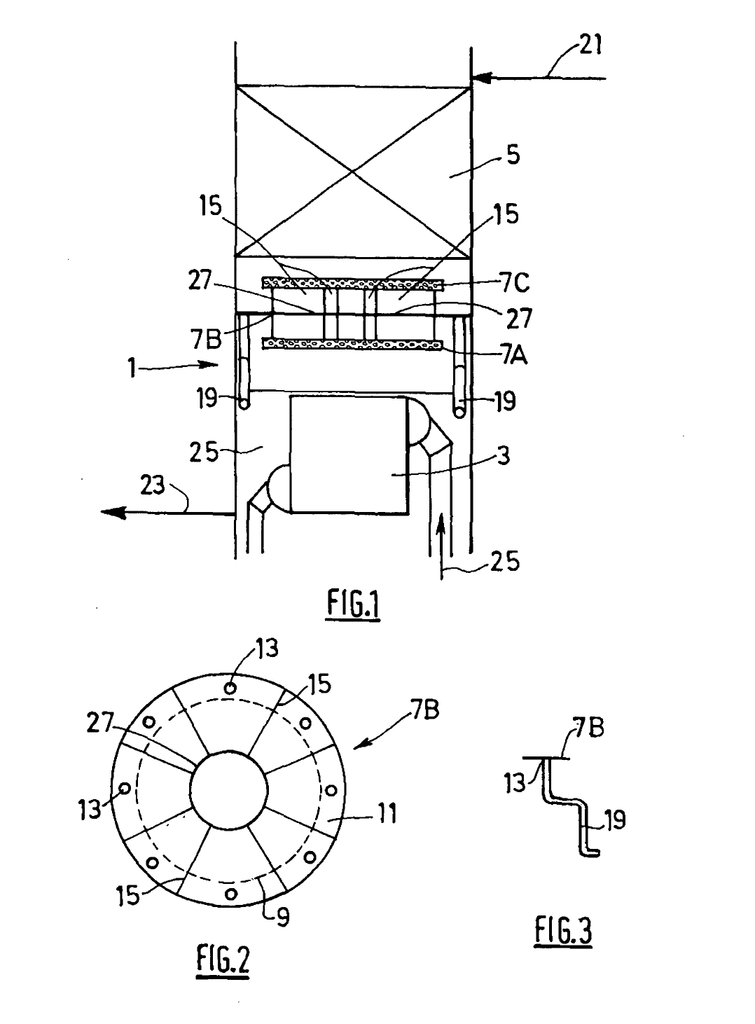

FIG. 1 shows a distillation column incorporating a firebreak device according to the invention,

FIG. 2 shows in detail one of the barriers according to the invention, and

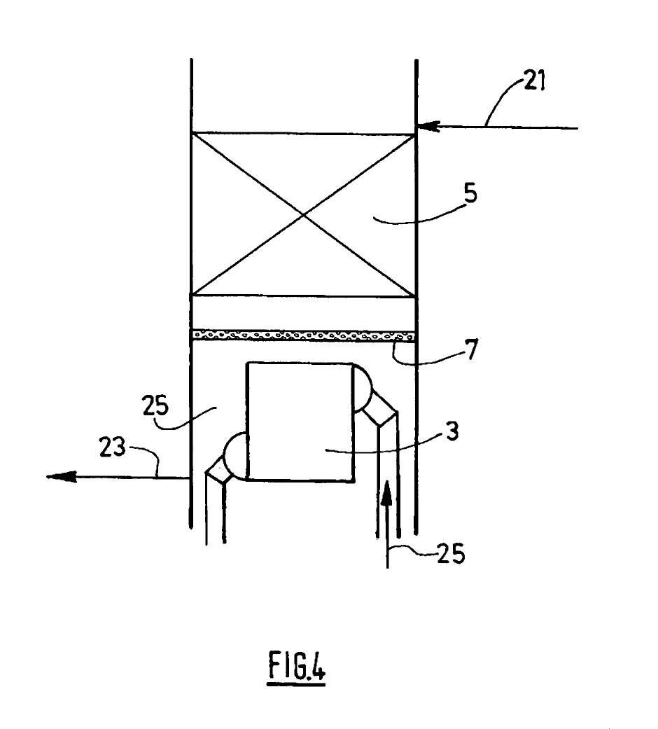

FIG. 3 shows a liquid downpipe.

The low-pressure column 1 of a double air-separation column has a sump reboiler 3 warmed by nitrogen 25 coming from the medium-pressure column. The reboiler serves to vaporize the sump liquid of the column, which is rich in oxygen. The reboiler 3 may be of any known type, but a reboiler of the bath vaporizer type is often preferred. The column is fed with reflux streams, including a stream of rich liquid 21, and optionally with a gaseous air stream. The mass and heat exchange inside the column takes place via at least one structured-packing module. These packings are preferably made of aluminum and are of the cross-corrugated type, but they may be of any type suitable for the separation of air, for example made of copper. The lowermost module 5 is located above the inlet for the rich liquid 21.

A stream 23 of oxygen-rich liquid containing between 80 and 99.9 mol % oxygen is withdrawn as column bottoms.

Placed between the sump reboiler 3 and the lowermost packing module 5 is a firebreak device consisting of three barriers, placed one on top of another.

The diameter of the low-pressure column 1 is typically 4.5 m.

The barrier closest to the reboiler 3 is the barrier 7A, which is a grid supporting a bed of several layers of ceramic beads, which have the advantage of being completely inert (neither a fuel nor an oxidizer) and of flowing by gravity toward the fire in the event of the grid being pierced by a vaporizer fire. These beads will be of a size sufficient not to risk blocking the exchanger channels (for example 12.7 mm).

Positioned above the barrier 7A is a barrier 7B responsible for recuperating the liquid oxygen. It consists of a metal sheet of annular shape, having an outside diameter substantially equal to the diameter of the column and typically an inside diameter of 1.5 m. The material may be copper or nickel or an alloy thereof (cupro-nickel or Monel®), but it may also be stainless steel covered with a ceramic or with a metal mentioned above. This barrier is fastened to the shell of the column 1 by welding. The barrier 7B includes an upturn 27 at the inner edge, in order to prevent liquid from flowing onto the barrier 7A. Eight radial reinforcing gussets 15 extend from the upturned edge 27 to the shell of the column 1. These gussets 15 make the barrier stronger and connect it to the barriers 7A and 7C so as to keep them in place. Formed around the perimeter of the barrier 7B are eight openings 13. The liquid falling through the center of the barrier 7B flows toward the outside of the barrier and is channeled into the openings 13. To reduce the mass of liquid oxygen present on the barrier 7B, the latter is filled with ceramic beads. Optionally, this barrier may be conical, and the upturn 27 will then be omitted.

The barrier 7C is of the same shape, of the same dimensions and of the same material as the barrier 7A, but at its center a solid metal sheet, typically 2.5 m in diameter, prevents liquid from dropping onto the barrier 7A. This barrier 7C is the final barrier and the number of ceramic bead layers may be smaller than in the barrier 7A.

It will be understood that the invention applies to any distillation column using a sump reboiler and at least one structured-packing module above the reboiler. In particular, it applies to columns in which the sump contains a liquid oxidizer.

As it is known that propagation can take place only if the temperature of the combustion products is above 1500° C., the number of barriers is preferably limited to three.

In FIG. 2, the outer edge of the barriers 7A and 7C below and above the barrier 7B is shown by the dotted line. This free annular space makes it possible to further reduce the pressure drops in operation.

FIG. 3 shows a liquid downpipe 19, which lets the liquid falling onto the barrier 7B flow through the openings 3. This downpipe 19 directs the liquid into the liquid bath 25. The downpipe has an elbowed shape, being bent at three different locations at an angle of 90°, so that the liquid leaves horizontally. In this way, fire propagation via the liquid downpipe is prevented.

The barriers may be made of copper or nickel or alloys thereof (cupro-nickel, Monel®) in order to ensure maximum safety. Another solution may be to coat an austenitic steel support with a copper alloy or with a ceramic.

FIG. 4 shows another column according to the invention. Here the firebreak consists of a single barrier in this case having the diameter of the column, formed from ceramic beads held in place by means of a grid. Glass or quartz beads could also be used. Since these materials have a very high melting point (greater than 2000° C. in the case of ceramics), this would form a shield preventing fire propagation if the number of layers is greater.

The beads forming a shield several centimeters in thickness let the liquid and the gas flowing through the column pass through them, but they remain inert. In the case of the start of overheating, the grid melts, thus releasing the beads, which drop into the fire. These beads will be of sufficient size not to risk blocking the exchanger channels (for example 12.7 mm).

Other systems may be placed between the ceramic bead barrier and the packing module so as to collect the liquid oxygen, while letting the gas through it, such as for example inverted-tile-shaped sectors placed on two different levels.

1-12. (canceled)

13. A distillation column comprising:
i) means for bringing at least one mixture to be distilled to the column;
ii) means for withdrawing at least one fluid enriched with a component of the mixture from the column;
iii) inside the column, a condenser-vaporizer and means for sending a gas to be condensed and a liquid to be vaporized to the condenser-vaporizer and means for withdrawing the condensed gas and the vaporized liquid; and
iv) at least one packing module located above the condenser-vaporizer,
wherein it includes at least one firebreak barrier placed between the condenser-vaporizer and the packing module, and also means for letting fluids flow inside the column between the module and the condenser-vaporizer.

14. The column of claim 13, which includes a first barrier obstructing a first portion of the section of the column equal to at least half of the section and a second barrier obstructing a second portion of the section of the column equal to at least half of the section and at most partly covering the first portion of the section of the column, the first and second barriers being located between the condenser-vaporizer and the first packing module above the condenser-vaporizer, the first barrier being below the second barrier.

15. The column of claim 14, which includes at least a third barrier above the second barrier and below the first packing module, obstructing a second portion of the section of the column equal to at least half of the section and at most partly covering the second portion of the section of the column.

16. The column of claim 15, in which the second portion of the section covers between 10 and 90% of the third portion of the section.

17. The column of claim 14, in which the first portion of the section covers between 10 and 90% of the second portion of the section.

18. The column of claim 13, in which the (or the first) barrier, and optionally the third barrier, consists of a disk coaxial with the column and obstructing a first section having a radius equal to between 50% and 100% of the radius of the column at the vaporizer.

19. The column of claim 18, in which the second barrier is an annular barrier having an outer radius substantially equal to that of the column at the vaporizer and having an inner radius substantially greater than 20% of that of the column at the vaporizer.

20. The column of claim 13, in which the barriers are at least partly made of copper or a copper alloy.

21. The column of claim 13, in which at least one barrier, preferably the lowest barrier and therefore the closest to the vaporizer, is filled with ceramic, quartz or glass beads.

22. The column of claim 13, in which at least one of the barriers is circular and/or at least one of the barriers is annular.

23. The column of claim 22, in which at least one of the barriers is centered on the vertical axis of the column.

24. Air distillation unit comprising at least one column of claim 13.
